(19) United States
(12) Patent Application Publication
(10) Pub. No.: US 2024/0192091 A1
(43) Pub. Date: Jun. 13, 2024

(54) METHOD AND APPARATUS FOR EVALUATING HEALTH OF VEHICLE CHASSIS

(71) Applicants: Aktiebolaget SKF, Göteborg (SE); SKF (China) Co. Ltd., Shanghai (CN)

(72) Inventors: Xing Yi, Shanghai (CN); Yuanbing Yao, Shanghai (CN); Jim Wei, Shanghai (CN); Sumeng Lian, Shanghai (CN)

(21) Appl. No.: 18/528,033

(22) Filed: Dec. 4, 2023

(30) Foreign Application Priority Data
Dec. 12, 2022 (CN) 202211597247.7

(51) Int. Cl. G01M 17/007

(52) U.S. Cl. CPC G01M 17/007

(57) ABSTRACT

A vehicle chassis health evaluation method and apparatus is disclosed. The method for health evaluation of vehicle chassis may include monitoring the vibration of at least one of the wheel end and the reducer by a vibration sensor. The vibration sensor is installed in the wheel end and/or the reducer. The method may further include, based on the monitored vibration of at least one of the wheel end and the reducer, performing the health evaluation of the vehicle chassis. The health evaluation method of the vehicle chassis of the present disclosure allows the real-time state of the vehicle chassis to be determined, even when the vehicle is driving, and critical safety accidents caused by the chassis can be avoided.

### CROSS-REFERENCE TO RELATED APPLICATION

This application claims priority to Chinese Application No. 202211597247.7, filed Dec. 12, 2022, the entirety of which is hereby incorporated by reference.

### FIELD

The disclosure relates to a method and an apparatus for evaluating health of vehicle chassis.

### BACKGROUND

Vehicle chassis can support and install the vehicle engine and its components and assemblies, form the overall shape of the vehicle, and receive the power of the engine, so that the vehicle can move and ensure the normal driving of the vehicle.

At present, for the health of the vehicle chassis, the maintenance engineer can evaluate the chassis state by surface observation (for example, the degree of component wear, etc.) when the vehicle is parked, or directly replace the components periodically (every predetermined time or every predetermined mileage). However, depending on the lighting conditions and the experience of maintenance engineers, there is great uncertainty in evaluating the chassis through surface observation. For long-distance vehicles, it is unrealistic to evaluate the chassis by parking in road sections of non-service areas. In addition, direct replacing of components periodically increases the unnecessary cost of vehicle transportation. Therefore, there is a need for a method and an apparatus that can automatically evaluate the health of vehicle chassis.

### SUMMARY

According to an embodiment of the present disclosure, a method and an apparatus for evaluating the health of a vehicle chassis are provided, through the monitoring data of a vibration sensor, the real-time status of the vehicle chassis can be provided when the vehicle is driving, so as to avoid critical safety accidents caused by the chassis.

According to an embodiment of the present disclosure, there is provided a method for health evaluation of vehicle chassis, comprising: monitoring the vibration of at least one of the wheel end and the reducer by a vibration sensor, wherein the vibration sensor is installed in the wheel end and/or the reducer; based on the monitored vibration of at least one of the wheel end and the reducer, the health evaluation of the vehicle chassis is performed.

According to the vehicle chassis health evaluation method of the embodiment of the present disclosure, wherein the health evaluation of the vehicle chassis performed based on the monitored vibration of at least one of the wheel end and the reducer further comprises: based on the fusion of the monitored vibration of at least one of the wheel end and the reducer and the monitoring data monitored by at least one other sensor, the health evaluation of the vehicle chassis is performed, wherein the health evaluation includes anomaly detection and/or fault diagnosis.

According to the vehicle chassis health evaluation method of the embodiment of the present disclosure, wherein the monitoring data monitored by the at least one other sensor includes one or more of the following: the temperature of at least one of the wheel end, the reducer and the oil of the reducer monitored by a temperature sensor installed on the wheel end and/or the reducer; the rotating speed of the wheel end monitored by a speed sensor installed on the wheel end; parameters of oil of the reducer monitored by an oil sensor installed in the reducer, wherein the parameters of the oil include at least part of the following: viscosity, density, dielectric constant, water content and metal particle content of the oil; parameters of grease of a bearing contained in at least one of the wheel end and the reducer monitored by a grease sensor installed in the bearing included in at least one of the wheel end and the reducer, wherein the parameters of grease include at least part of the following: trace moisture, percentage of oil in grease, and metal particle content; abnormal sound of at least a part of wheel end, reducer and other mechanical parts of chassis monitored by acoustic sensors installed on the wheel end and/or the reducer.

According to the vehicle chassis health evaluation method of the embodiment of the present disclosure, wherein the health evaluation comprises detecting faults of the bearing contained in at least one of the wheel end and the reducer and/or faults related to the wheel end based on the fusion of the monitoring data of the vibration sensor and the at least one other sensor, wherein the at least one other sensor comprises at least one of the acoustic sensor, the temperature sensor, the speed sensor and the grease sensor, wherein the faults of bearings contained in at least one of the wheel end and the reducer include peeling of the inner ring, peeling of the outer ring, peeling of the roller element, breakage of the retainer, lubrication faults, wherein the faults related to the wheel end include tire defects, tire imbalance and brake locking.

According to the vehicle chassis health evaluation method of the embodiment of the present disclosure, wherein the health evaluation comprises detecting faults of reducer based on the fusion of monitoring data of the vibration sensor and the at least one other sensor, wherein the at least one other sensor comprises at least one of an acoustic sensor, a temperature sensor, a speed sensor and an oil sensor, wherein the faults of the reducer includes abnormal oil, broken gear teeth, gear teeth wear.

According to the vehicle chassis health evaluation method of the embodiment of the present disclosure, wherein the health evaluation comprises detecting a mechanical faults based on the fusion of monitoring data of the vibration sensor and the at least one other sensor, wherein the at least one other sensor comprises at least one of the acoustic sensor and the speed sensor, wherein the mechanical faults include screw loosening and abnormal chassis resonator.

According to the vehicle chassis health evaluation method of the embodiment of the present disclosure, wherein the fusion comprises assigning weights to the monitoring data of the vibration sensor and the at least one other sensor.

According to the vehicle chassis health evaluation method of the embodiment of the present disclosure, wherein the fusion comprises, based on the monitoring data of the at least one other sensor, adjusting the result of health evaluation of the vehicle chassis performed based on the monitored vibration of at least one of the wheel end and the reducer.

According to the vehicle chassis health evaluation method of the embodiment of the present disclosure, wherein the anomaly detection and/or the fault diagnosis are performed by an algorithm including a combination of a classical mechanism model and/or a machine learning model.

According to the vehicle chassis health evaluation method of the embodiment of the present disclosure, wherein the health evaluation comprises: uploading data to be evaluated for health evaluation of the vehicle chassis to a server, wherein the data to be evaluated is associated with monitoring data of the vibration sensor; receiving the early fault of the chassis and estimated the remaining useful lifetime of the chassis from the server, wherein, the early fault of the chassis and estimated the remaining useful lifetime of the chassis are performed by an algorithm driven by big data and a machine learning model and based on the data to be evaluated.

According to an embodiment of the present disclosure, there is provided a vehicle chassis health evaluation apparatus, comprising: a vibration sensor configured to monitor vibration of at least one of the wheel end and the reducer, wherein the vibration sensor is installed in the wheel end and/or the reducer; and a control unit configured to perform health evaluation on the vehicle chassis based on the monitored vibration of at least one of the wheel end and the reducer.

According to the vehicle chassis health evaluation method and apparatus of the embodiment of the present disclosure, the health evaluation of the vehicle chassis can be performed based on the monitoring data of the vibration sensor, thereby reducing accidental faults or reducing maintenance costs.

Furthermore, one or more of the monitoring data monitored by at least one other sensor is fused to evaluate the health of the vehicle chassis, for example, the health of the vehicle chassis is comprehensively evaluated through the data monitored by one or more of the temperature sensor, speed sensor, oil sensor, grease sensor and acoustic sensor, so that the health evaluation is more accurate, and accidents and maintenance costs are further reduced.

### BRIEF DESCRIPTION OF THE DRAWINGS

The above and other aspects, features and advantages of specific embodiments of the present disclosure will become more apparent from the following description taken in conjunction with the accompanying drawings, in which:

FIG. 1a is a hardware schematic diagram according to an embodiment of the present disclosure,

FIG. 1b is another hardware schematic diagram according to an embodiment of the present disclosure,

FIG. 1c is yet another hardware schematic diagram according to an embodiment of the present disclosure,

FIG. 2a is a flowchart of health evaluation of a vehicle chassis through monitoring data of a vibration sensor according to an embodiment of the present disclosure,

FIG. 2b is another flow chart of health evaluation of vehicle chassis through the fusion of monitoring data of sensors according to the embodiment of the present disclosure,

FIG. 3a is a flowchart of health evaluation of a vehicle chassis through an evaluation algorithm according to an embodiment of the present disclosure, and

FIG. 3b is another flowchart of health evaluation of a vehicle chassis through an evaluation algorithm according to an embodiment of the present disclosure.

### DETAILED DESCRIPTION

Before proceeding to the following detailed description, it may be beneficial to set forth the definitions of certain words and phrases used throughout this patent document. The terms “include” and “contain” and their derivatives refer to including but not limited to. The term “controller” or “control unit” refers to any device, system or a part thereof that controls at least one operation. Such controller may be implemented with hardware or a combination of hardware and software and/or firmware. The functions associated with any particular controller can be centralized or distributed, whether local or remote. The phrase “at least one”, when used with a list of items, means that different combinations of one or more of the listed items can be used, and only one item in the list may be needed. For example, “at least one of A, B and C” includes any one of the following combinations: A, B, C, A and B, A and C, B and C, A and b and C.

Definitions of other specific words and phrases are provided throughout this patent application document. It should be understood by those skilled in the art that in many cases, if not most cases, such definitions also apply to the previous and future uses of words and phrases so defined.

The following description of various embodiments of the principles of the present disclosure in this patent application document taken in conjunction with the accompanying drawings is for illustration only and should not be interpreted as limiting the scope of the present disclosure in any way. Those skilled in the art will understand that the principles of the present disclosure can be implemented in any suitably arranged system or device. In some cases, the actions described in the specification can be performed in a different order and still achieve the desired results. Moreover, the processes depicted in the drawings do not necessarily require the specific order or sequential order shown to achieve the desired results. In certain embodiments, multitasking and parallel processing may be advantageous.

Vehicles used throughout this disclosure may include any motor vehicle, such as cars, tractors (with or without trailers), buses, recreational vehicles, minivan or sport utility vehicles (SUVs) and the like.

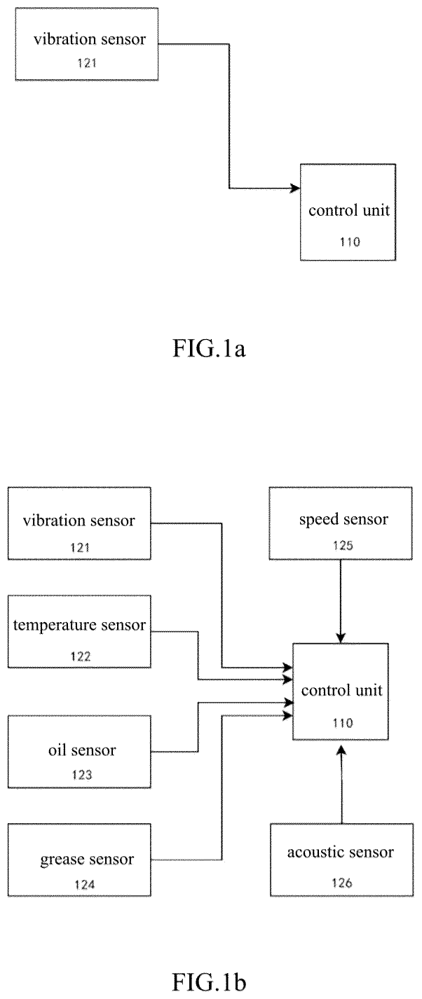

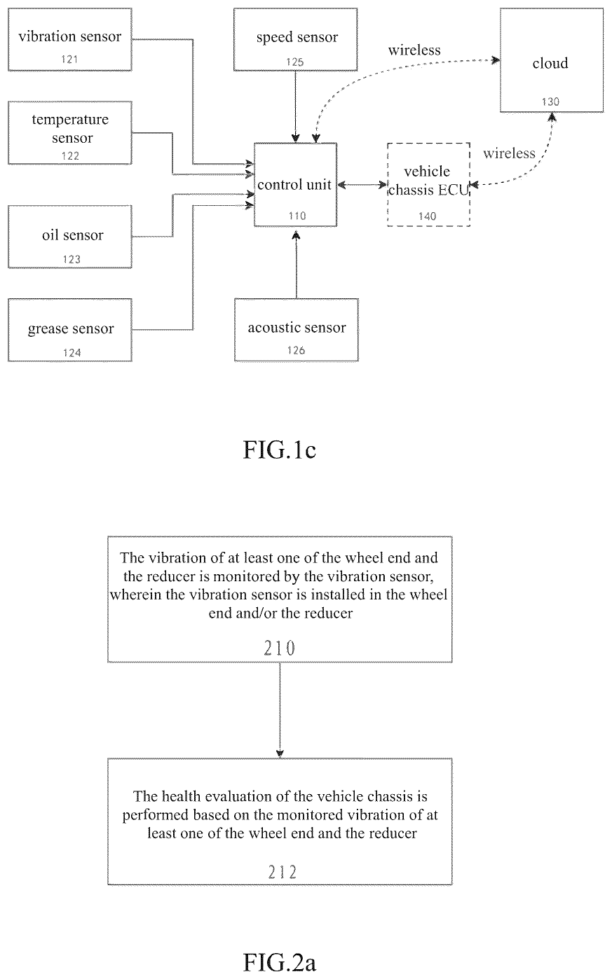

Although a storage is not shown in FIGS. 1a-1c, those skilled in the art will understand that the control unit may include one or more storages on which instructions and/or data are stored. In addition, although FIGS. 1a-1c functionally show the control unit 110 and the sensors as being in a single frame, those skilled in the art will understand that the control unit 110 and the sensors may actually include a plurality of control units 110 and a plurality of sensors of the same type, which may or may not be stored in the same physical housing. Therefore, a reference to a control unit 110 or a sensor will be understood to include a reference to a set of control units 110 and a set of sensors of the same type operating in parallel or not.

FIG. 1a is a schematic diagram of hardware according to an embodiment of the present disclosure.

The hardware schematic diagram according to the embodiment of the present disclosure as shown in FIG. 1a may mainly include a control unit 110 and a vibration sensor 121.

The control unit 110 may be any conventional control unit, such as a commercially available CPU. Alternatively, the control unit 110 may be a dedicated device, such as an ASIC or other hardware-based control unit.

The vibration sensor 121 may include, but is not limited to, a mechanical vibration sensor, an optical vibration sensor and an electrical vibration sensor (such as an inductive vibration sensor, an eddy current vibration sensor, a capacitive vibration sensor, a resistance strain vibration sensor and a piezoelectric vibration sensor). The vibration sensor 121 may be configured to monitor vibration of at least one of the wheel end and the reducer. In one embodiment, the vibration sensor may be mounted in the wheel end and/or the reducer. The wheel end may include a bearing, a hub and a rim. The wheel end and the reducer are coupled through various mechanical components (such as a drive shaft and a steering gear).

The connection part between the control unit 110 and the sensors (including the aforementioned vibration sensors and other types of sensors described below) can be connection part in any form that can at least transmit the signals output by the sensors to the control unit 110. In one embodiment, the connection part includes one or both of a cable connection form and a wireless connection form.

The connection part in the form of cable connection may include cables for transmitting analog signals (for example, voltage and 4-20 mA current) or digital signals (pulse, CAN, RS485, etc.). The connection part in the form of cable is more suitable for applications that need high performance acquisition and high reliability.

The connection part in the form of wireless connection may include various configurations and protocols, including short-range communication protocols such as Bluetooth™ and Bluetooth™ LE, sub GHz, wireless HART, infrared link, ZigBee, Radio Frequency Identification (RFID), WiFi, Internet, World Wide Web, Intranet, virtual private network, wide area network, local area network, private network using communication protocols exclusive to one or more companies, Ethernet and HTTP, and a combination of foregoing. The connection part in the form of wireless connection is more suitable for the requirements of easy installation and small size.

FIG. 1b is another hardware schematic diagram according to an embodiment of the present disclosure.

Another hardware schematic diagram according to an embodiment of the present disclosure as shown in FIG. 1b may further include one or more of a temperature sensor 122, an oil sensor 123, a grease sensor 124, a speed sensor 125 and an acoustic sensor 126. For brevity and clarity, the same components are not described repeatedly.

The temperature sensor 122 may include, but is not limited to, contact temperature sensors (such as bimetallic thermometers, glass liquid thermometers, pressure thermometers, resistance thermometers, thermistors, thermocouples, etc.) and non-contact temperature sensors (such as various non-contact temperature sensors based on radiation thermometry including luminance method, radiation method and colorimetry method). The temperature sensor 122 may be configured to monitor the temperature of at least one of the wheel end, the reducer and the oil of the reducer. In one embodiment, the temperature sensor 122 may be mounted in the wheel end and/or the reducer.

The oil sensor 123 may include, but is not limited to, oil viscosity sensors (such as various viscosity sensors based on capillary method, falling ball method, vibration method, rotation method, ultrasonic wave, optical technology, electromagnetic principle, electromagnetic tomography technology, etc.), oil dielectric constant sensors (capacitive, quartz crystal microbalance oil dielectric constant sensors, etc.), oil particle quantity sensors (such as, one or more of fluid condition monitor (FCM), quantitative debris monitor (QDM), metal particle detector (MPD), tracer debris measuring instrument, ferrograph, acoustic emission debris detection technology, ultrasonic debris monitoring method, optical debris sensor, etc). Oil has the function of lubrication. The oil sensor 123 may be configured to monitor the parameters of the oil of the reducer. The parameters of oil can include viscosity, density, dielectric constant, water content, metal particle content and so on. The oil sensor 123 may be installed in the reducer. For example, the oil sensor 123 can be installed at the lower part of the reducer, and spaced apart from the bottom of the reducer one third to one fifth, the oil sensor 123 collects corresponding data through contacting with the oil, and further obtains the parameters of the oil of the reducer according to the processing of the collected data. In one embodiment, the oil sensor 123 directly sends the collected data to the control unit 110, and the control unit 110 processes the collected data to obtain the oil parameters of the reducer.

The grease sensor 124 may be configured to monitor a grease parameter of a bearing included in at least one of the wheel end and the reducer. Grease also has the function of lubrication, and it has better adhesion compared with oil. The grease parameters of the bearing included in at least one of the wheel end and the reducer may include trace moisture, percentage of oil in the grease, metal particle content, etc. In one embodiment, the grease sensor 124 may be installed in a bearing included in at least one of the wheel end and the reducer. For example, by digging an accommodation space in an appropriate position of the bearing, the grease sensor 124 is installed in the accommodation space, and the grease sensor 124 collects corresponding data through contacting with the grease in the bearing, and further obtains the grease parameters of the bearing according to the processing of the collected data. In one embodiment, the grease sensor 124 directly transmits the collected data of the bearing at which it located to the control unit 110, and the control unit 110 processes the collected data to obtain the grease parameters of the bearing.

The speed sensor 125 may include, but is not limited to, a photoelectric speed sensor, a magnetoelectric speed sensor, a Hall speed sensor, and the like. The speed sensor may be configured to monitor the rotational speed of the wheel end. In one embodiment, the speed sensor 125 may be mounted in the wheel end.

The acoustic sensor 126 may include, but is not limited to, a piezoelectric ceramic acoustic sensor, a capacitive acoustic sensor, a magnetoelectric acoustic sensor, and the like. The acoustic sensor may be configured to monitor abnormal sounds of one or more of the wheel end, the reducer and other mechanical parts of the chassis. In one embodiment, the acoustic sensor may be mounted in the wheel end and/or the reducer. For example, the acoustic sensor can be installed at the same position as the vibration sensor.

In one embodiment, a plurality of sensors of the temperature sensor, vibration sensor, acoustic sensor and speed sensor above can be integrated into one sensor, and the one sensor can collect different types of data. For example, a vibration sensor and an acoustic sensor can be integrated into one sensor, which can collect both vibration signals and acoustic signals.

FIG. 1c is a schematic diagram of yet another hardware according to an embodiment of the present disclosure. For brevity and clarity, the same components are not described repeatedly.

Another hardware schematic diagram according to an embodiment of the present disclosure as shown in FIG. 1c may also include a cloud 130. The cloud 130 may include a server (e.g., a load balancing server group) having a plurality of computing devices that exchange information with different control units 110 in order to receive data from, process data and send data to the control units 110. For example, the cloud 130 may include one or more server computing devices capable of communicating with one or more control units 110 via wireless communication. Cloud 130 may also include servers in roadside stations. Cloud 130 can provide more computing power as well as big data and machine learning models.

The connection between the control unit and the cloud may be via the internal cellular module of the control unit and/or various configurations and protocols. The internal cellular module can use various cellular communication technologies, such as GSM, CDMA, UMTS, EV-DO, WiMAX, LTE or 5th generation “5G” cellular technology and other cellular technology developed in the future. Various configurations and protocols include short-range communication protocols, such as Bluetooth™, Bluetooth™ LE, sub GHz, wireless HART, infrared link, ZigBee, Radio Frequency Identification (RFID), WiFi, Internet, World Wide Web, Intranet, Virtual Private Network, Wide Area Network, Local Area Network, private network using communication protocols exclusive to one or more companies, Ethernet and HTTP, and various combinations of the foregoing.

Alternatively, another hardware schematic diagram according to an embodiment of the present disclosure as shown in FIG. 1c may further include a vehicle chassis electronic control unit 140. The ECU 140 may be configured to relay communication between the control unit 110 and the cloud 130.

In one embodiment, the connection between the control unit and the cloud can also be relayed via the vehicle chassis ECU. For example, the vehicle chassis ECU 140 may receive processed sensor data or raw sensor data from the control unit 110 and forward the data to the cloud 130. The vehicle chassis ECU 140 may also receive the health evaluation result from the cloud 130 and forward the health evaluation result to the control unit 110.

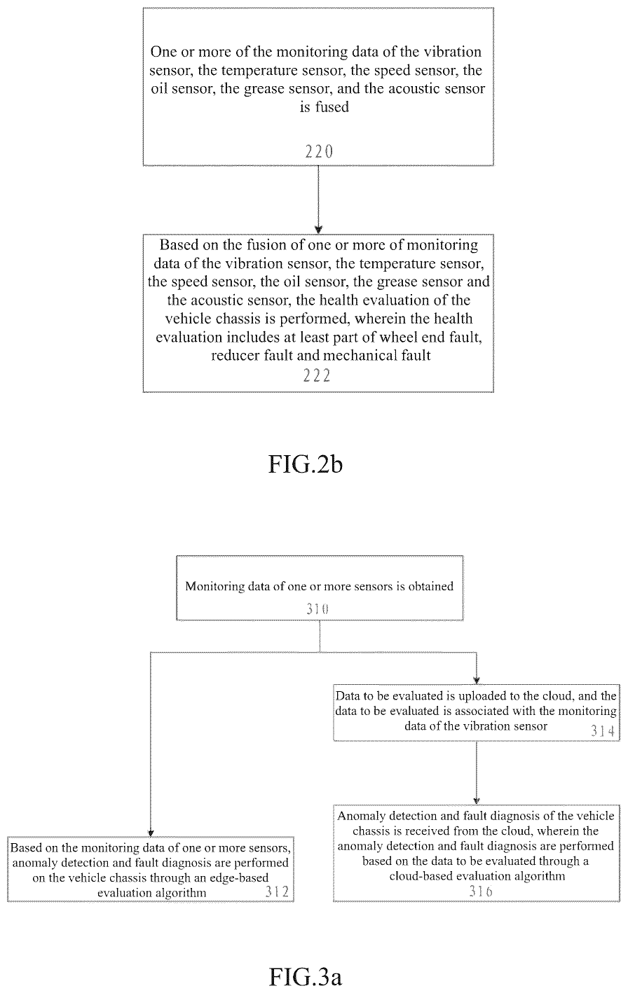

FIG. 2a is a flowchart of health evaluation of a vehicle chassis through monitoring data of a vibration sensor according to an embodiment of the present disclosure.

Referring now to FIG. 1a, FIG. 2a is described, at block 210, the vibration of at least one of the wheel end and the reducer is monitored by the vibration sensor 121. For example, the vibration sensor 121 may monitor a total vibration value or a vibration spectrum of vibration of at least one of the wheel end and the reducer.

At block 212, the health evaluation of the vehicle chassis may be performed based on the monitored vibration of at least one of the wheel end and the reducer. For example, the features of vibration signals are extracted, and whether there is an abnormal feature value is determined according to the probability distribution of a plurality of vibration feature values. If the abnormal feature value is greater than a predetermined anomaly threshold, it is decided that the vehicle chassis is abnormal. Here, a correlation feature extraction algorithm can be used to extract features from multiple vibration signals to obtain multiple vibration features, which can include one or more of the following features: time domain features, such as but not limited to mean, standard deviation, Root Mean Square (RMS), peak-to-peak value, skewness, kurtosis, etc. of signal; Frequency domain features, such as but not limited to harmonic position and amplitude, etc.

The health evaluation may include anomaly detection and/or fault diagnosis. In one embodiment, the deterioration of vehicle driving performance caused by the “fault” of components in the vehicle chassis may be more serious than that caused by the “anomaly” of components in the vehicle chassis. For example, the detected anomalies existed in components in the chassis (such as component wear, abnormal operation, etc.) may not have reached the level of fault. In addition, health evaluation can also diagnose the faults existed in the components in the chassis, including early, middle and late stage faults. Those skilled in the art should understand that in practical application, the boundary between the anomaly of components in the chassis and the early fault of components in the chassis may not be obvious or may overlap, and the term “anomaly” and the term “fault” may be used alternately in the following, which should not be regarded as the limitation of this disclosure.

Here, the health evaluation of the chassis can include the diagnosis of wheel end fault, reducer fault and mechanical fault. Wheel end faults can include faults of the wheel end itself (for example, bearings contained in the wheel end) and faults of peripheral components related to the wheel end (for example, tire defects, tire imbalance, brake lock, etc.). The faults of the reducer can include the faults of the bearing contained in the reducer, abnormal oil, broken gear teeth, gear teeth wear and so on. Mechanical faults can include, for example, screw loosening, chassis resonator anomaly and other faults. For example, when the total vibration value of the monitored vibration of at least one of the wheel end and the reducer exceeds the threshold, then wheel end fault, reducer fault, mechanical fault and the like are indicated. Alternatively, when the vibration spectrum of the monitored vibration of at least one of the wheel end and the reducer exceeds the threshold, then wheel end fault, reducer fault, mechanical fault and the like are indicated.

FIG. 2b is another flowchart of health evaluation of a vehicle chassis through fusion of monitoring data of sensors according to an embodiment of the present disclosure.

Referring now to FIG. 1b or 1c, FIG. 2b is described, at block 220, one or more of the monitoring data of the vibration sensor 121, the temperature sensor 122, the oil sensor 123, the grease sensor 124, the speed sensor 125 and the acoustic sensor 126 is fused.

At block 222, based on the fusion of one or more of monitoring data of vibration sensor 121, temperature sensor 122, oil sensor 123, grease sensor 124, speed sensor 125 and acoustic sensor 126, the health evaluation of the vehicle chassis is performed. The health evaluation may include but not limited to wheel end fault, reducer fault and mechanical fault. Based on the fusion of monitoring data of a plurality sensors, the accuracy of health evaluation of vehicle chassis can be improved, and more health evaluation of vehicle chassis may be performed.

In one embodiment, fusion may include assigning weights to one or more of monitoring data of vibration sensors, speed sensors, temperature sensors, oil sensors, grease sensors, and acoustic sensors. For example, respective weights can be assigned to confidence (for example, indications of the possibility of correctly identifying the specified faults) scores of specified faults indicated by different sensors, so as to obtain a fused confidence score of the specified faults. The fused confidence score of the specified fault can have higher accuracy than that of the specified fault indicated by a single type of sensor.

In another embodiment, the fusion may include adjusting the threshold of the vibration sensor based on one or more of the monitoring data of the temperature sensor, the speed sensor, the oil sensor, the grease sensor and the acoustic sensor. For example only, based on the temperature sensor indicating that the temperature of at least one of the wheel end and the reducer and the oil is higher than a threshold, the threshold of the vibration sensor may be decreased; based on the speed sensor indicating that the speed is higher than a threshold, the threshold of the vibration sensor can be increased; based on the oil sensor indicating that the parameters of oil exceed a threshold, the threshold of vibration sensor can be decreased; based on the grease sensor indicating parameters of grease exceed a threshold, the threshold of vibration sensor can be decreased; based on the acoustic sensor indicating that the abnormal sound is higher than a threshold, the threshold of vibration sensor can be decreased. Compared with the initial threshold of vibration sensor, the health evaluation based on the adjusted threshold of vibration sensor may have higher accuracy.

In another embodiment, the fusion may include extracting features from monitoring data of vibration sensors, speed sensors, temperature sensors, oil sensors, grease sensors and acoustic sensors, and combining the extracted features, thereby generating new features. The new features can indicate or be processed to indicate the health status of the vehicle chassis. Wherein, feature extraction can include obtaining root mean square (RMS), peak-to-peak (P2P), envelope 3 (envelope 3 is the feature extracted from the monitoring data of vibration sensors and acoustic sensors, for example) of monitoring data of sensors, and performing time-frequency transformation (such as FFT transformation) and numerical operation on the monitoring data of sensors. Wherein, the combination of extracted features includes numerical operation and so on. But the present disclosure is not limited thereto.

In one embodiment, based on the fusion of the monitoring data of the vibration sensor with the acoustic sensor, the temperature sensor, the speed sensor and the grease sensor, the fault of the bearing contained in at least one of the wheel end and the reducer and/or the fault related to the wheel end can also be detected. Alternatively, based on the fusion of the monitoring data of the vibration sensor and at least one of the acoustic sensor, the temperature sensor, the speed sensor and the grease sensor (such as based on the fusion of the monitoring data of the vibration sensor and the grease sensor), it is also possible to detect the fault of the bearing contained in at least one of the wheel end and the reducer and/or the fault related to the wheel end. The fault of the bearing contained in at least one of the wheel end and the reducer may include peeling of the inner ring, peeling of the outer ring, peeling of the roller element, breakage of the retainer, lubrication fault, and the like. Faults related to wheel ends can include tire defects, tire imbalance, brake lock, etc. In one embodiment, based on any one of a vibration sensor, a temperature sensor, and an acoustic sensor, a fault related to the wheel end can also be detected.

In another embodiment, based on the fusion of the monitoring data of the vibration sensor with the acoustic sensor, the temperature sensor, the speed sensor and the oil sensor, at least part of the fault of the reducer can also be detected. Alternatively, based on the fusion of monitoring data of the vibration sensor and at least one of the acoustic sensor, the temperature sensor, the speed sensor and the oil sensor (such as based on the fusion of monitoring data of the vibration sensor and the oil sensor), at least a part of the fault of the reducer can also be detected. At least a part of the faults of the reducer can include abnormal oil, broken gear teeth, gear teeth wear and so on. In one embodiment, based on any one of vibration sensor, temperature sensor and acoustic sensor, the fault of the reducer can also be detected.

In yet another embodiment, based on the fusion of monitoring data of vibration sensor with acoustic sensor and speed sensor, mechanical fault can also be detected. Alternatively, the mechanical fault can also be detected based on the fusion of the monitoring data of the vibration sensor with at least one of the acoustic sensor and the speed sensor (such as based on the fusion of the monitoring data of the vibration sensor with the acoustic sensor). Mechanical faults include screw loosening and abnormal chassis resonator. For example, it is possible to monitor abnormal sound and vibration near corresponding positions by placing acoustic sensors and vibration sensors at different positions. In one embodiment, the fault of the reducer can also be detected based on any one of the vibration sensor and the acoustic sensor.

The basic principle of fault detection for wheel end fault, reducer fault and mechanical fault in the embodiment of the application is that the feature values of vibration and acoustic emission extracted in time domain and transform domain (such as peak-peak value of vibration speed, vibration envelope value, etc.) are combined with temperature data, and faults are classified by a classification algorithm to identify faults. In general, the phenomenon that materials or members release strain energy in the form of elastic waves when they are deformed or cracked during the stress process is called acoustic emission.

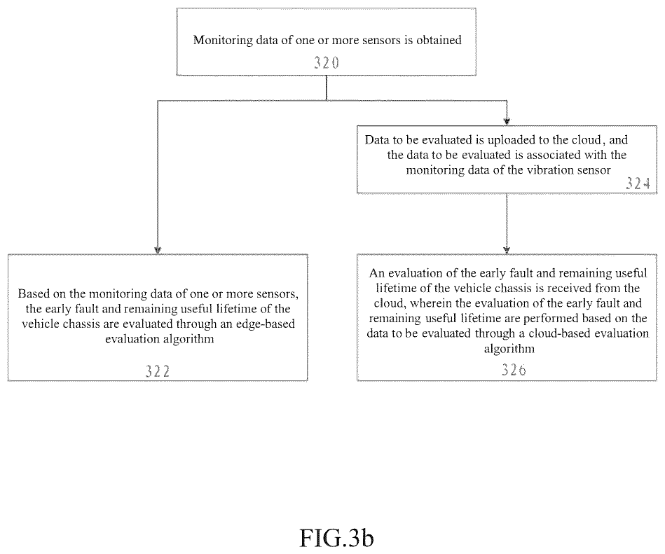

FIG. 3a is a flowchart of health evaluation of a vehicle chassis through an evaluation algorithm according to an embodiment of the present disclosure.

Referring now to FIG. 1b or 1c, FIG. 3a is described, at block 310, monitoring data of one or more of vibration sensor 121, temperature sensor 122, oil sensor 123, grease sensor 124, speed sensor 125 and acoustic sensor 126 is obtained.

At block 312, based on the monitoring data of one or more sensors, anomaly detection and fault diagnosis are performed on the vehicle chassis through an edge-based evaluation algorithm. The edge-based evaluation algorithm means that the algorithm is arranged at the edge, that is, near the sensor side or the vehicle side. For example, the evaluation algorithm may be stored on the control unit 110. The evaluation algorithm may be stored on the control unit 110. So that anomaly detection and fault diagnosis can be performed locally on the vehicle chassis on the control unit 110. The evaluation algorithm may include an algorithm combining the classical mechanism model and the machine learning model. This may be advantageous in the case where the computing power of the control unit 110 is sufficient or communication is blocked. The classical mechanism model can be or include a traditional model for analyzing the health status of the chassis by using the classical dynamics theory.

In one embodiment, for the anomaly detection process, in response to detecting an anomaly, for example, only a specific anomaly that exists in the corresponding component and has not reached the level of fault is indicated. For the fault diagnosis process, in response to the fault diagnosis, the specific faults of the corresponding components and the corresponding treatment methods can be indicated. Further, faults can be divided into early stage faults, mid stage faults and late stage faults, which can correspond to different further treatments, such as replacing faulty components, stopping for manual maintenance and so on.

At block 314, data to be evaluated can be uploaded to the cloud 130, and the data to be evaluated is associated with the monitoring data of the vibration sensor. In one embodiment, the data to be evaluated may include one or both of the raw monitoring data of one or more sensors and the monitoring data of one or more sensors on which preprocessing and feature extraction were performed. For example, the raw monitoring data of one or more sensors can be uploaded directly to the cloud 130. Alternatively, preprocessing and feature extraction can be performed on the raw monitoring data of one or more sensors at the control unit 110, so that the monitoring data of one or more sensors on which preprocessing and feature extraction were performed can be uploaded to the cloud 130.

At block 316, anomaly detection and fault diagnosis of the vehicle chassis can be received from the cloud 130, wherein the anomaly detection and fault diagnosis are performed based on the data to be evaluated (raw monitoring data of one or more sensors and/or monitoring data of one or more sensors that were preprocessed and feature extracted) through a cloud-based evaluation algorithm. Cloud-based evaluation algorithms can include algorithms that combine classical mechanism models and machine learning models. This may be advantageous if the control unit 110 has insufficient computing power or smooth communication. However, in some cases, the control unit 110 can periodically or continuously upload sensor data to the cloud 130 even if the vehicle does not need to perform health evaluation at the cloud 130.

FIG. 3b is another flowchart of health evaluation of a vehicle chassis through an evaluation algorithm according to an embodiment of the present disclosure.

Referring now to FIG. 1b or 1c, FIG. 3a is described, at block 320, monitoring data of one or more of vibration sensor 121, temperature sensor 122, oil sensor 123, grease sensor 124, speed sensor 125 and acoustic sensor 126 is obtained.

At block 322, based on the monitoring data of one or more sensors, the early fault and remaining useful lifetime of the vehicle chassis are evaluated through an edge-based evaluation algorithm. The edge-based evaluation algorithm means that the algorithm is arranged at the edge, that is, near the sensor side or the vehicle side. For example, the evaluation algorithm may be stored on the control unit 110. So that the early fault and the remaining useful lifetime of the vehicle chassis can be evaluated locally on the control unit 110. The evaluation algorithm may include advanced algorithms via big data driving and machine learning models. This may be advantageous in the case where the computing power of the control unit 110 is sufficient or communication is blocked.

In block 324, data to be evaluated can be uploaded to the cloud 130, and the data to be evaluated is associated with the monitoring data of the vibration sensor. In one embodiment, the data to be evaluated may include one or both of raw monitoring data of one or more sensors and monitoring data of one or more sensors on which preprocessing and feature extraction were performed. For example, the raw monitoring data of one or more sensors can be uploaded directly to the cloud 130. Alternatively, preprocessing and feature extraction can be performed on the raw monitoring data of one or more sensors at the control unit 110, so that the monitoring data of one or more sensors on which preprocessing and feature extraction were performed can be uploaded to the cloud 130.

At block 326, an evaluation of the early fault and remaining useful lifetime of the vehicle chassis is received from the cloud 130. Uploaded raw monitoring data of one or more sensors can be preprocessed and feature extracted in the cloud. Moreover, the evaluation of the early fault and the remaining useful lifetime is performed based on the data to be evaluated (raw monitoring data of one or more sensors and/or monitoring data of one or more sensors that were preprocessed and feature extracted) through a cloud-based evaluation algorithm. Cloud-based evaluation algorithms may include advanced algorithms driven by big data and machine learning models. This may be advantageous if the control unit 110 has insufficient computing power or smooth communication. However, in some cases, the control unit 110 can periodically or continuously upload sensor data to the cloud 130 even if the vehicle does not need to perform health evaluation at the cloud 130.

The cloud 130 may include a server with a plurality of computing devices, thereby providing greater computing power. In addition, the cloud can also provide big data and machine learning models that can be updated in real time.

In one embodiment, big data may include monitoring data of the same type of sensors of other vehicles on the corresponding chassis components. Other vehicles may include the same type of vehicles or different types of vehicles with the same type of axles. The current terrain information (e.g., slope and radius of curvature, pitch, elevation, etc.) obtained by the cloud 130 based on the positioning information of the current vehicle can be compared with the terrain information of the road stored in the cloud 130, so as to identify the monitoring data of the same type of sensors of other vehicles in the same or similar road conditions on the corresponding chassis components. In addition, the meteorological information (for example, wind information or rainfall information) obtained in real time through the cloud 130 based on the positioning information of the current vehicle can be compared with the meteorological information stored in the cloud 130, so as to identify the monitoring data of the same type of sensors of other vehicles in the same or similar meteorological conditions on the corresponding chassis components. For example, when the monitoring data of a certain type of sensor of the current vehicle on a chassis component is higher than the monitoring data of the same type of sensor of other vehicles of the same type in the same road conditions and the same meteorological conditions on the corresponding chassis component stored in the cloud 130 by a predetermined threshold, fault occurring in the chassis component of the current vehicle may be indicated.

In one embodiment, big data may include historical monitoring data of the same type of sensors of the same vehicle on the corresponding chassis components. Considering that the same vehicle may repeatedly commute to similar road sections, the historical monitoring data of the same vehicle may be more available for the health evaluation of the chassis of the same vehicle. For example, when the monitoring data of a certain type of sensor of the current vehicle on a chassis component is higher than the historical monitoring data of the same vehicle within the threshold time of replacing the corresponding chassis component on the corresponding chassis component, fault occurring in the chassis component of the current vehicle may be indicated.

In one embodiment, big data may include monitoring data of the same type of sensors (such as vibration sensors) of the driving vehicle on other chassis components of the same type (such as other wheel ends or other reducers). For example, when the monitoring data of the same type sensor (such as a vibration sensor) of a driving vehicle on a specific chassis component (one of the wheel ends) is higher than the monitoring data of the same type sensor (such as a vibration sensor) on other chassis components (other wheel ends) belonging to the same type as the specific chassis component by a predetermined threshold, fault occurring in the specific chassis component (one of the wheel ends) may be indicated.

The machine learning model can use any of a variety of models, such as decision tree, model based on generative adversarial network, deep learning model, linear regression model, logical regression model, neural network, classifier, support vector machine, inductive logic programming, ensemble of models (for example, using technologies such as bagging, lifting, random forest, etc.), genetic algorithm, Bayesian network, etc., and can be trained by various methods, such as deep learning, association rules, inductive logic, clustering, maximum entropy classification, learning classification, etc. In some examples, the machine learning model may use supervised learning. In some examples, the machine learning model uses unsupervised learning.

According to the on-line health evaluation solution of the vehicle chassis disclosed by the invention, the real-time state of the vehicle chassis can be provided even when the vehicle is driving, thus critical safety accidents caused by the chassis can be avoided. This method can also detect the early fault of chassis and provide maintenance suggestions for customers, so as to keep the maintenance in the early fault stage, thus avoiding unplanned faults. Before causing damage to people and vehicles, detect chassis faults (such as wheel end bearings, gear teeth wear of reducer, aging of reducer oil, etc.). By combining different types of sensors, the detection accuracy can be improved and the false positive rate can be reduced.

The text and drawings are provided as examples only to help understand the present disclosure. They should not be construed as limiting the scope of the present disclosure in any way. Although certain embodiments and examples have been provided, based on the disclosure herein, it is apparent to those skilled in the art that changes can be made to the illustrated embodiments and examples without departing from the scope of this disclosure.

Although the present disclosure has been described with exemplary embodiments, various changes and modifications can be suggested to those skilled in the art. This disclosure is intended to cover such changes and modifications as fall within the scope of the appended claims.

Any description in the present invention should not be understood as implying that any particular element, step or function is an essential element that must be included within the scope of the claims. The scope of the patent subject matter is limited only by the claims.

What is claimed is:

1. A method for health evaluation of vehicle chassis comprising:
monitoring the vibration of at least one of the wheel end and the reducer by a vibration sensor, wherein the vibration sensor is installed in the wheel end and/or the reducer;
based on the monitored vibration of at least one of the wheel end and the reducer, performing the health evaluation of the vehicle chassis.

2. The method according to claim 1, wherein based on the monitored vibration of at least one of the wheel end and the reducer, performing the health evaluation of the vehicle chassis further comprises:
based on the fusion of the monitored vibration of at least one of the wheel end and the reducer and the monitoring data monitored by at least one other sensor, performing the health evaluation of the vehicle chassis, wherein the health evaluation includes anomaly detection and/or fault diagnosis.

3. The method according to claim 2, wherein the monitoring data monitored by the at least one other sensor includes one or more of the following:
the temperature of at least one of the wheel end, the reducer and the oil of the reducer monitored by a temperature sensor installed on the wheel end and/or the reducer;
the rotating speed of the wheel end monitored by a speed sensor installed on the wheel end;
parameters of oil of the reducer monitored by an oil sensor installed in the reducer, wherein the parameters of the oil include at least part of the following: viscosity, density, dielectric constant, water content and metal particle content of the oil;
parameters of grease of a bearing contained in at least one of the wheel end and the reducer monitored by a grease sensor installed in the bearing included in at least one of the wheel end and the reducer, wherein the parameters of the grease include at least part of the following: trace moisture, percentage of oil in grease, and metal particle content;
abnormal sound of at least a part of wheel end, reducer and other mechanical parts of chassis monitored by an acoustic sensor installed on the wheel end and/or the reducer.

4. The method according to claim 3, wherein the health evaluation comprises detecting faults of the bearing contained in at least one of the wheel end and the reducer and/or faults related to the wheel end based on the fusion of the monitoring data of the vibration sensor and the at least one other sensor,
wherein the at least one other sensor comprises at least one of the acoustic sensor, the temperature sensor, the speed sensor and the grease sensor,
wherein the faults of bearings contained in at least one of the wheel end and the reducer include peeling of the inner ring, peeling of the outer ring, peeling of the roller element, breakage of the retainer, lubrication faults, wherein the faults related to the wheel end include tire defects, tire imbalance and brake locking.

5. The method according to claim 3, wherein the health evaluation comprises detecting faults of reducer based on the fusion of monitoring data of the vibration sensor and the at least one other sensor,
wherein the at least one other sensor comprises at least one of the acoustic sensor, the temperature sensor, the speed sensor and the oil sensor,
wherein the faults of the reducer include abnormal oil, broken gear teeth, gear teeth wear.

6. The method according to claim 3, wherein the health evaluation comprises detecting mechanical faults based on the fusion of monitoring data of the vibration sensor and the at least one other sensor,
wherein the at least one other sensor comprises at least one of the acoustic sensor and the speed sensor,
wherein the mechanical faults include screw loosening and abnormal chassis resonator.

7. The method according to claim 3, wherein the fusion comprises assigning weights to the monitoring data of the vibration sensor and the at least one other sensor.

8. The method according to claim 3, wherein the fusion comprises, based on the monitoring data of the at least one other sensor, adjusting the result of health evaluation of the vehicle chassis performed based on the monitored vibration of at least one of the wheel end and the reducer.

9. The method according to claim 6, wherein the fusion comprises assigning weights to the monitoring data of the vibration sensor and the at least one other sensor.

10. The method according to claim 6, wherein the fusion comprises, based on the monitoring data of the at least one other sensor, adjusting the result of health evaluation of the vehicle chassis performed based on the monitored vibration of at least one of the wheel end and the reducer.

11. The method according to claim 2, wherein the anomaly detection and/or the fault diagnosis are performed by an algorithm including a combination of a classical mechanism model and/or a machine learning model.

12. The method according to claim 1, wherein the health evaluation comprises:
uploading data to be evaluated for health evaluation of the vehicle chassis to a server, wherein the data to be evaluated is associated with monitoring data of the vibration sensor;
receiving the early fault of the chassis and estimated the remaining useful lifetime of the chassis from the server,
wherein, the early fault of the chassis and estimated the remaining useful lifetime of the chassis are performed by an algorithm driven by big data and a machine learning model and based on the data to be evaluated.

13. An apparatus for health evaluation of vehicle chassis comprising:
a vibration sensor configured to monitor vibration of at least one of the wheel end and the reducer, wherein the vibration sensor is installed in the wheel end and/or the reducer; and
a control unit configured to perform health evaluation on the vehicle chassis based on the monitored vibration of at least one of the wheel end and the reducer.
